(19) United States
(12) Patent Application Publication
(10) Pub. No.: US 2010/0120288 A1
(43) Pub. Date: May 13, 2010

(54) Multi-level electrical terminal crimp

(76) Inventors: George Albert Drew, Warren, OH (US); William J. Palm, Warren, OH (US); Bruce S. Gump, Warren, OH (US); Mark David Baranski, Warren, OH (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/291,813

(22) Filed: Nov. 13, 2008

(51) Int. Cl. H01R 9/05; H01R 43/04

(52) U.S. Cl. 439/585; 29/863

(57) ABSTRACT

A cable assembly includes a terminal crimped to a conductor. The terminal has a plurality of crimps spaced from one another and a transition crimp disposed therebetween. A method includes deforming the terminal about the conductor to define the plurality of crimps having different crimp heights, and deforming the terminal about the conductor to define the transition crimp between each of the plurality of crimps. The transition crimp has a crimp height different than each of the plurality of crimps.

### BACKGROUND

Electrical devices are commonly connected together using some type of electrical cable assembly that includes an electrical conductor (such as conductor or coax cable assembly) and a conductive terminal. The terminals are generally metal tubes or a U-shaped metal that is squeezed around the conductor. The crimping action effectively reforms the terminal around the conductor to form a strong electrical and physical connection. Often, the reliability of the electrical device depends in part on the quality of the connection created between the terminal and the conductor (i.e., the “crimp”). Thus, crimping not only provides for electrical connectivity, but also provides a mechanical connection for protection against torsional and tensional forces. These forces can damage the terminal or the conductor and disrupt the electrical connection.

Most commonly, crimped connections have been used to attach copper conductors to terminals. However, due to the lower cost and weight of aluminum, conductors formed from aluminum or aluminum alloys are becoming a prevalent alternative to copper. The same types of crimped connections that are commonly used for copper, however, don't always perform well with aluminum-based materials because of the corrosive products that accumulate on the surface of the terminal and/or conductor that can impede the electrical connection and weaken the physical connection.

Known crimp-style connections tend to use the force or pressure of the crimping action alone to make the electrical and mechanical connections between the terminal and the conductor. This force, however, tends to damage or break either the conductor or the terminal. If less crimping force is used to prevent damage or breakage, the electrical or mechanical connections may not be adequate for the needs of the system. Moreover, creating an effective electrical connection between the terminal and the conductor using a pressure contact method is impeded by various corrosion products on the surface of the terminal and the conductor.

Various methods have been employed to overcome these impediments, but few have been successful in high volume manufacturing environments. Making an electrically stable contact with the conductor for long periods of time and over many different environmental factors generally includes overcoming surface corrosion on both the conductor and the terminal by breaking through corrosion products to expose non-corroded portions of the conductor, removing the corrosion products on the surface of the terminal, and electrically connecting the non-corroded portions of the conductor and terminal to one another in a manner that will be physically stable over time, temperature, and other environmental changes. This type of connection is especially difficult when aluminum conductor is used due to the low hardness of the aluminum combined with corrosion products on the aluminum, which are often much harder than the aluminum itself.

Thus, there is a need for a connector that provides a firm electrical and mechanical connection without causing damage or breakage to the conductor and/or terminal, and can overcome connection impediments due to corrosion.

### BRIEF SUMMARY

A cable assembly includes a terminal crimped to a conductor. The terminal has a plurality of crimps spaced from one another and a transition crimp disposed therebetween.

A method includes deforming the terminal about the conductor to define the plurality of crimps having different crimp heights, and deforming the terminal about the conductor to define the transition crimp between each of the plurality of crimps. The transition crimp has a crimp height different than each of the plurality of crimps.

### BRIEF DESCRIPTION OF THE DRAWINGS

FIG. 1 is a perspective view of an exemplary cable assembly having multi-stage crimps, according to an embodiment.

### DETAILED DESCRIPTION

A cable assembly includes a terminal crimped to a conductor, such as a wire. The terminal has a plurality of crimps spaced from one another and a transition crimp disposed therebetween. One of the crimps is tighter against the conductor and maximizes the electrical connection between the conductor and the terminal. Another of the crimps maximizes the pull-out strength of the conductor. However, an abrupt change in crimp heights between these two crimps may actually reduce the electrical and/or physical connection between the conductor and the terminal. Therefore, the transition crimp minimizes the impact of the abrupt change in crimp heights between the plurality of crimps, thus allowing the conductor to have a strong electrical and physical connection to the terminal. A crimping tool is used to form the cable assembly and form the plurality of crimps and transition crimp. The crimping tool deforms the terminal about the conductor to define the plurality of crimps and the transition crimp between each of the plurality of crimps such that the transition crimp and each of the plurality of crimps have different crimp heights.

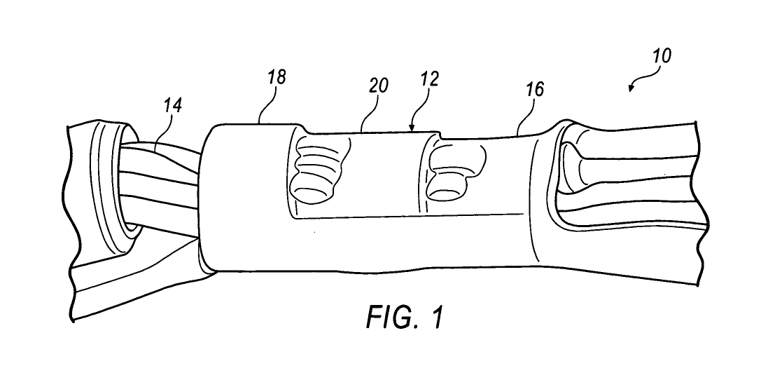

FIG. 1 is a perspective view of an exemplary cable assembly 10 having multi-stage crimps. In one exemplary approach, the cable assembly 10 includes a terminal 12 crimped to a conductor 14, such as a wire. In other words, the terminal 12 is deformed about the conductor 14 to provide a strong physical and electrical connection to the conductor 14. The terminal 12 has a plurality of crimps spaced from one another. Specifically, the terminal 12 defines at least a first crimp 16 and a second crimp 18. Moreover, the terminal 12 defines a transition crimp 20 disposed between each of the plurality of crimps.

The conductor 14 may be formed from various materials, including aluminum or aluminum-based materials. Because aluminum or aluminum-based conductors may develop oxide coatings, a tight crimp is often needed to form a strong electrical connection. Accordingly, the first crimp 16 is tighter about the conductor 14 than the second crimp 18 and the transition crimp 20 to remove the oxide coating and effectively maximize an electrical contact between the conductor 14 and the terminal 12. Although tightly crimping the terminal 12 to the conductor 14 may increase the electrical contact, it may also reduce the physical connection between the terminal 12 and the conductor 14. A reduced physical connection means that the conductor 14 is able to be pulled out from the terminal 12 more easily. In other words, the first crimp 16 may decrease the pull-out strength of the conductor 14. Therefore, in one exemplary approach, the second crimp 18 is looser than the first crimp 16. This way, the first crimp 16 maximizes the electrical contact between the terminal 12 and the conductor 14, while the second crimp 18 effectively maximizes the pull-out strength of the conductor 14 from the terminal 12. The combination of the first crimp 16 and the second crimp 18 allow the terminal 12 to have a strong physical and electrical connection to the conductor 14.

Because the first crimp 16 is tighter on the conductor 14 than the second crimp 18, the first crimp 16 has a crimp height that is smaller than a crimp height of the second crimp 18. In one embodiment, the crimp height of the first crimp 16 is 0.35 mm smaller than the crimp height of the second crimp 18. It is to be appreciated that such an abrupt change in crimp height may actually reduce the electrical and/or physical connection of the conductor 14 to the terminal 12. In other words, the large difference in crimp heights may weaken the electrical connection and/or the pull-out strength of the conductor 14 relative to the terminal 12. Therefore, the transition crimp 20 is provided to allow a large difference in crimp heights between the first crimp 16 and the second crimp 18 without sacrificing the electrical and/or physical connection of the conductor 14 to the terminal 12. The first crimp 16 is tighter on the conductor 14 than the transition crimp 20, and the transition crimp 20 is tighter on the conductor 14 than the second crimp 18. Therefore, the transition crimp 20 has a crimp height that is configured to provide a transition between the first crimp 16 and the second crimp 18. In one exemplary approach, the height of the transition crimp 20 is less than 0.35 mm larger than the first crimp 16, and less than 0.35 mm smaller than the second crimp 18.

It is to be appreciated that the first crimp 16, the second crimp 18, and the transition crimp 20 may be integrally formed with the terminal 12. Also, it is to be appreciated that the terminal 12 may include any number of crimps spaced from one another with additional transition crimps 22 disposed therebetween. Furthermore, it is to be appreciated that the terminal 12 having the first crimp 16, the second crimp 18, and the transition crimp 20 as described herein may meet various industry quality standards, such as standards set forth by the United States Council for Automotive Research (USCAR), among others. For example, the cable assembly 10 disclosed herein may meet the requirements for USCAR21, which is a crimp validation specification, and USCAR20, which is a field correlated life test.

A crimping tool (not shown) may be used to deform the terminal 12 about the conductor 14 to form the first crimp 16 and the second crimp 18, and specifically, to crimp the terminal 12 so that each crimp has a different crimp height. Moreover, the crimping tool may deform the terminal 12 about the conductor 14 to define the transition crimp 20 between the first crimp 16 and the second crimp 18. As a result, the cable assembly 10 includes the terminal 12 where the first crimp 16, the second crimp 18, and the transition crimp 20 each have different crimp heights. In order to form the different crimp heights, the crimping tool may crimp the terminal 12 such that the first crimp 16 is tighter than the second crimp 18 and the transition crimp 20, and the transition crimp 20 is tighter on the conductor 14 than the second crimp 18. The crimping tool may be configured or shaped such that the first crimp 16, the second crimp 18, and the transition crimp 20 are formed simultaneously. In other words, the terminal 12 may be deformed in a single action by the crimping tool, instead of being deformed in two or more separate crimping actions. Moreover, it is appreciated that the crimping tool may deform the terminal 12 to have more than two crimps, with each crimp having a transition crimp 20 therebetween. Accordingly, the crimping tool may form any number of crimps and transition crimps 22 in the terminal 12.

Although the terminal 12 is shown as a double-notch terminal (i.e., the terminal 12 has two “windows” at the top of the crimp), the terminal 12 may instead have zero, one, or any other number of notches.

The above description is intended to be illustrative and not restrictive. Many alternative approaches or applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. In sum, it should be understood that the invention is capable of modification and variation and is limited only by the following claims.

The present embodiments have been particularly shown and described, which are merely illustrative of the best modes. It should be understood by those skilled in the art that various alternatives to the embodiments described herein may be employed in practicing the claims without departing from the spirit and scope as defined in the following claims. It is intended that the following claims define the scope of the invention and that the method and apparatus within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

We claim:

1. A cable assembly comprising:
a conductor; and
a terminal crimped to said conductor,
wherein the terminal has a plurality of crimps spaced from one another and a transition crimp disposed therebetween.

2. A cable assembly as set forth in claim 1, wherein at least one of said plurality of crimps maximizes an electrical contact between said conductor and said terminal.

3. A cable assembly as set forth in claim 1, wherein at least one of said plurality of crimps maximizes a pull-out strength of said conductor from said terminal.

4. A cable assembly as set forth in claim 1, wherein one of said plurality of crimps is tighter on said conductor than another of said plurality of crimps.

5. A cable assembly as set forth in claim 1, wherein one of said plurality of crimps is tighter on said conductor than said transition crimp, and said transition crimp is tighter on said conductor than another of said plurality of crimps.

6. A cable assembly as set forth in claim 1, wherein said plurality of crimps and said transition crimp are integrally formed with said terminal.

7. A cable assembly as set forth in claim 1, wherein said transition crimp has a crimp height configured to provide a transition between each of said plurality of crimps.

8. A cable assembly as set forth in claim 1, wherein one of said plurality of crimps has a crimp height approximately 0.35 mm smaller than a crimp height of another of said plurality of crimps.

9. A cable assembly as set forth in claim 1, wherein said conductor includes aluminum or an aluminum-based material.

10. A cable assembly as set forth in claim 1, wherein said terminal meets USCAR21 requirements.

11. A cable assembly as set forth in claim 1, wherein said terminal meets USCAR20 requirements.

12. A method comprising:
deforming a terminal about a conductor to define a plurality of crimps having different crimp heights; and
deforming the terminal about the conductor to define a transition crimp between each of the plurality of crimps and having a crimp height different than each of the plurality of crimps.

13. A method as set forth in claim 12, wherein at least one of the plurality of crimps maximizes an electrical contact between the conductor and the terminal.

14. A method as set forth in claim 12, wherein at least one of the plurality of crimps maximizes a pull-out strength of the conductor from the terminal.

15. A method as set forth in claim 12, wherein deforming the terminal to define the plurality of crimps includes crimping the terminal such that one of the plurality of crimps is tighter against the conductor than another of the plurality of crimps.

16. A method as set forth in claim 12, wherein deforming the terminal to define the plurality of crimps includes crimping the terminal such that one of the plurality of crimps is tighter against the conductor than the transition crimp.

17. A method as set forth in claim 16, wherein deforming the terminal to define the transition crimp includes crimping the terminal such that the transition crimp is tighter against the conductor than another of the plurality of crimps.

18. A method as set forth in claim 12, wherein deforming the terminal to define the plurality of crimps includes crimping one of the plurality of crimps to have a crimp height approximately 0.35 mm smaller than a crimp height of another of the plurality of crimps.

19. A method as set forth in claim 12, wherein the conductor includes aluminum or an aluminum-based material.

20. A method as set forth in claim 12, wherein deforming the terminal to define the plurality of crimps is simultaneous with deforming the terminal to define the transition crimp.
